(19) United States
(12) Patent Application Publication
(10) Pub. No.: US 2011/0273273 A1
(43) Pub. Date: Nov. 10, 2011

(54) Methods and Apparatus of a Multi-Frequency RFID System

(75) Inventor: JUN LIU, Vienna, VA (US)

(73) Assignee: JUN LIU, Vienna, VA (US)

(21) Appl. No.: 13/098,399

(22) Filed: Apr. 29, 2011

Related U.S. Application Data
(60) Provisional application No. 61/329,095, filed on Apr. 29, 2010.

(51) Int. Cl. H04Q 5/22

(52) U.S. Cl. 340/10.1

(57) ABSTRACT

Methods and apparatus of a RFID system in which multiple frequency bands are utilized are described herein. In one aspect, a dual frequency RFID system consists of dual frequency RFID tags which operate at the first frequency band and the second frequency band, RFID readers which operate at the first frequency band at the first environment, RFID readers which operate at the second frequency band at the second environment; wherein the first environment is supply chain and the second environment is hospital.

### RELATED APPLICATIONS INFORMATION

The application claims the benefit under 35 U.S.C. 119(e) of U.S. Provisional Patent Application Ser. No. 61/329,095, filed Apr. 29, 2010 and entitled “Methods and Apparatus of a Multi-Frequency RFID System,” which is incorporated herein by reference in its entirety.

### BACKGROUND

Passive RFID technologies can be applied to different frequency bands, for example, 433 MHz, 900 MHz (UHF), 2.4 GHz, 5 GHz, or UWB (Ultra-Wideband: 3.1 to 10.6 GHz) bands. RFID in different frequency bands has different performance characteristics. For example, under FCC Part 15, assuming UHF tags and 2.4 GHz tags have the same antenna metrics (gain and directivity), A UHF tag can be read at a longer distance than a 2.4 GHz tag; but when multiple tags are present, 2.4 GHz tags can be read more reliably than UHF tags due to less mutual coupling among tags. To make a tag at a particular frequency band, its antenna impedance needs to match its chip impedance for maximum energy transfer or utilization. As such, making a multi-frequency tag requires multiple chips and antennas.

There exists a need to make a multi-frequency tag by using a single passive RFID chip and to have a multi-frequency system based upon.

### SUMMARY

Methods and apparatus of a RFID system in which multiple frequency bands are utilized are described herein.

In one aspect, an apparatus of a dual frequency RFID tag is made by a single RFID chip which has a memory block, a digital block and a RF block, the first antenna which has the impedance match to the impedance of the RF block at the first frequency band, and the second antenna has the impedance match to the impedance of the RF block at the second frequency band; wherein mutual couplings between the first antenna and the second antenna are minimized in their respective frequency bands.

In another aspect, an apparatus of a dual frequency RFID tag is made by a single RFID chip which has a memory block, a digital block, the first RF block and the second RF block, the first antenna has the impedance match to the impedance of the first RF block at the first frequency band, and the second antenna has the impedance match to the impedance of the second RF block at the second frequency band; wherein mutual couplings between the first antenna and the second antenna are minimized in their respective frequency bands.

In another aspect, a dual frequency RFID system consists of dual frequency RFID tags which operate at the first frequency band and the second frequency band, RFID readers which operate at the first frequency band at the first environment, RFID readers which operate at the second frequency band at the second environment; wherein the first environment is supply chain and the second environment is hospital.

### BRIEF DESCRIPTION OF THE DRAWINGS

Features, aspects, and embodiments are described in conjunction with the attached drawings, in which:

FIG. 1 is a diagram illustrating a dual frequency RFID tag configured in accordance with one example embodiment.

FIG. 2 is a diagram illustrating a dual frequency RFID tag configured in accordance with another example embodiment.

FIG. 3 is a diagram illustrating a dual frequency RFID system configured in accordance with one embodiment.

### DETAILED DESCRIPTION

1. Multi-Frequency Tag

Two methods of making a dual-frequency tag are presented herein. One method is to use a chip having only one RF block while the other is to use a chip having two RF blocks. These two methods can be used to make a multi-frequency tag without loss of generality.

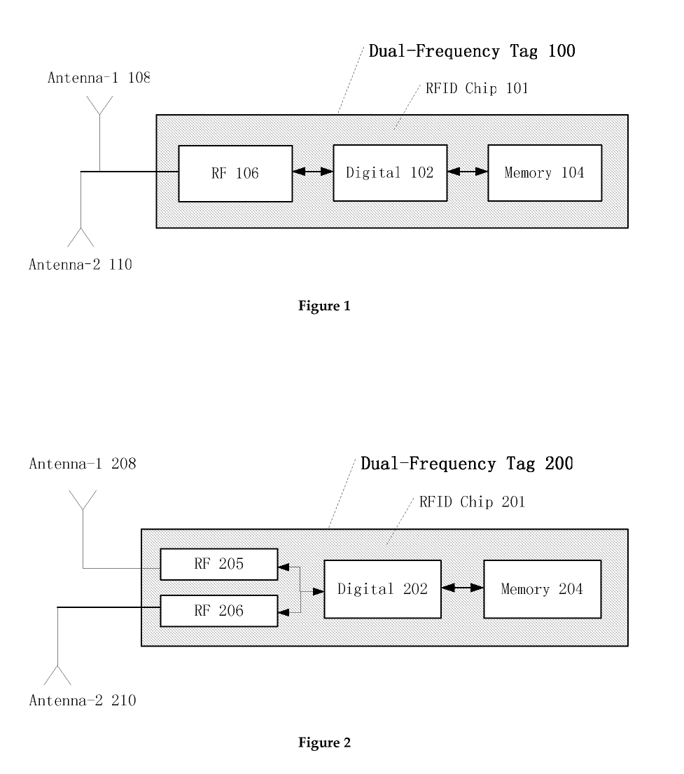

As shown in FIG. 1, a Dual-Frequency Tag 100 consists of a RFID Chip 101, Antenna-1 108 and Antenna-2 110. The RFID Chip 101 consists of a Digital block 102, a memory block 104 and a RF block 106. For example, the RFID chip may be a Higgs chip from Alien Technology or a Ucode chip from NXP. Antenna-1 108 has the impedance match to the impedance of RF 106 at Frequency-1 while Antenna-2 110 has the impedance match to the impedance of RF 106 at Frequency-2. Frequency-1 and Frequency-2 may be 433 MHz, 900 MHz (UHF), 2.4 GHz or 5 GHz, or UWB (Ultra-Wideband: 3.1 to 10.6 GHz) bands, respectively. For example, Frequency-1 is in the 900 MHz band and Frequency-2 is in the 2.4 GHz band. When Antenna-1 108 and Antenna-2 110 are designed, the mutual couplings between them in the two frequency bands are taken into account such that the mutual couplings do not adversely affect each antenna in its respective frequency band.

As shown in FIG. 2, a Dual-Frequency Tag 200 consists of a RFID Chip 201, Antenna-1 208 and Antenna-2 210. The RFID Chip 201 consists of a Digital block 202, a memory block 204, two RF blocks 205 and 206. For example, the RFID chip may be a Monza chip from Impinj Inc, which has two antenna ports. Antenna-1 208 has the impedance match to the impedance of RF 205 at Frequency-1 while Antenna-2 210 has the impedance match to the impedance of RF 206 at Frequency-2. Frequency-1 and Frequency-2 may be 433 MHz, 900 MHz (UHF), 2.4 GHz or 5 GHz, or UWB (Ultra-Wideband: 3.1 to 10.6 GHz) bands, respectively. For example, Frequency-1 is in the 900 MHz band and Frequency-2 is in the 2.4 GHz band. When Antenna-1 208 and Antenna-2 210 are designed, the mutual couplings between them in the two frequency bands are taken into account such that the mutual couplings do not adversely affect each antenna in its respective frequency band.

2. Multi-Frequency System

Without loss of generality, a dual-frequency system based on dual-frequency tags (Tag 100 and/or Tag 200 described above) is presented herein. The same principle without loss of merits can be applied to a multi-frequency system.

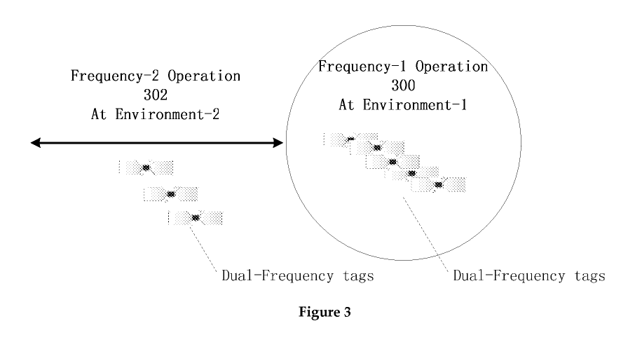

As shown in FIG. 3, Frequency-1 Operation 300 occurs at Environment-1: readers operate in the Frequency-1 band and dual-frequency tags respond in the Frequency-1 band; Frequency-2 Operation 302 occurs at Environment-2: readers operate in the Frequency-2 band and dual-frequency tags respond in the Frequency-2 band. Frequency-1 and Frequency-2 may be 433 MHz, 900 MHz (UHF), 2.4 GHz or 5 GHz, or UWB (Ultra-Wideband: 3.1 to 10.6 GHz) bands, respectively. For example, 2.4 GHz band (Frequency-1 Operation 300) is used at hospitals (Environment-1) for better multi-tag reading/sorting while 900 MHz band (Frequency-2 Operation 302) is used at supply chain (Environment-2) for logistic purpose. In this example, dual-frequency tags (2.4 GHz/900 MHz) are affixed or embedded into medical drugs or their packages and used at hospitals for 2.4 GHz operation, while these dual-frequency tags are also compliant to UHF (900 MHz) EPC (Electronic Product Code) requirements if needed in local or global logistics.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. An apparatus of a dual frequency RFID tag, comprising:
a single RFID chip which has a memory block, a digital block and a RF block,
the first antenna has the impedance match to the impedance of the RF block at the first frequency band,
the second antenna has the impedance match to the impedance of the RF block at the second frequency band.

2. An apparatus of claim 1 wherein the first frequency band is one of 433 MHz, 900 MHz (UHF), 2.4 GHz, 5 GHz and UWB.

3. An apparatus of claim 1 wherein the second frequency band is one of 433 MHz, 900 MHz (UHF), 2.4 GHz, 5 GHz and UWB.

4. An apparatus of claim 1 wherein the single RFID chip is one of a Higgs chip from Alien Technology and an Ucode chip from NXP.

5. An apparatus of claim 1 wherein mutual couplings between the first antenna and the second antenna are minimized in their respective frequency bands.

6. An apparatus of a dual frequency RFID tag, comprising:
a single RFID chip which has a memory block, a digital block, the first RF block and the second RF block,
the first antenna has the impedance match to the impedance of the first RF block at the first frequency band,
the second antenna has the impedance match to the impedance of the second RF block at the second frequency band.

7. An apparatus of claim 6 wherein the first frequency band is one of 433 MHz, 900 MHz (UHF), 2.4 GHz, 5 GHz and UWB.

8. An apparatus of claim 6 wherein the second frequency band is one of 433 MHz, 900 MHz (UHF), 2.4 GHz, 5 GHz and UWB.

9. An apparatus of claim 6 wherein the single RFID chip is a Monza chip from Impinj Inc.

10. An apparatus of claim 6 wherein mutual couplings between the first antenna and the second antenna are minimized in their respective frequency bands.

11. A dual frequency RFID system, comprising:
dual frequency RFID tags which operate at the first frequency band and the second frequency band,
RFID readers which operate at the first frequency band at the first environment,
RFID readers which operate at the second frequency band at the second environment.

12. The system of claim 11 wherein the first frequency band is one of 433 MHz, 900 MHz (UHF), 2.4 GHz, 5 GHz and UWB.

13. The system of claim 11 wherein the second frequency band is one of 433 MHz, 900 MHz (UHF), 2.4 GHz, 5 GHz and UWB.

14. The system of claim 11 wherein the first environment is supply chain and the second environment is hospital.

15. The system of claim 14 wherein 900 MHz (UHF) is used at the first environment and 2.4 GHz is used at the second environment.
